(19) United States
(12) Patent Application Publication
(10) Pub. No.: US 2002/0146210 A1
(43) Pub. Date: Oct. 10, 2002

(54) Walk-off compensation by tube rotation

(75) Inventor: Warren Hale Lewis, Sunnyvale, CA (US)

Correspondence Address: Hall, Priddy, Myers & Vande Sande, Suite 200, 10220 River Road, Potomac, MD, 20854, US

(73) Assignee: E-Tek Dynamics, Inc.

(21) Appl. No.: 09/828,355

(22) Filed: Apr. 9, 2001

(51) Int. Cl. G02B 6/38

(52) U.S. Cl. 385/61; 385/60; 385/73

(57) ABSTRACT

Optical devices, such as couplers, isolators and filters, are important building blocks in most WDM systems, within which light from a fiber is collimated, processed, and then focused onto another fiber. Unfortunately, during the processing of the light the beam gets walked-off from its initial path. In order for the light to fully couple between the fibers it is imperative that this walk-off be accounted for. Conventional systems simply mount the focusing lens and output ferrule offset from the collimating lens and input ferrule to ensure good coupling. However, there are several advantages to positioning the collimating lens coaxial with the focusing lens. Accordingly, the present invention relates to a method for optically coupling fibers with coaxial lenses by rotating an angle polished end face of at least one (preferably two) of the ferrules and lenses relative to the other ferrules and lenses. A greater range of positions is obtained when two of the ferrule and/or the lens are rotated. A passive alignment system is also disclosed in which the elements of the optical device are oriented at predetermined azimuth angles, relative to the optical axis thereof, based on a predetermined walk-off caused by the optical component in the centerpiece.

### FIELD OF THE INVENTION

The present invention relates to the optical coupling of an optical centerpiece, and in particular to the alignment of an input fiber, an input lens, an output fiber, an output lens and an optical component.

### BACKGROUND OF THE INVENTION

The standard optical centerpiece, as illustrated in FIG. 1, comprises an input fiber tube 1, a collimating lens 2, an optical component 3, a focusing lens 4, and an output fiber tube 5. In the illustrated example, the input fiber tube 1 includes an end of an input fiber 6 and an end of a reflection fiber 7 encased in a protective ferrule. The fiber tube 5 includes an end of a transmission fiber 8 encased in a protective ferrule. The collimating and focusing lenses 2 and 4 are typically ¼-pitch graded index lenses (GRIN), sold under the trade name “SELFOC” owned by Nippon Sheet and Glass Co. Ltd. of Japan. The optical component 3 can be any one of or a combination of a number of components used in the industry, including thin-film dichroic optical filters, isolator cores, rotators and beam splitters. In the illustrated example the optical component 3 is a thin-film filter. The mating surfaces on the lenses and the fiber tubes/ferrules are angle polished to minimize the coupling of reflected light off of those surfaces back into the fibers. The conventional alignment process for this device includes: aligning the input and reflection fibers 6 and 7 with the lens 2 and filter 3; aligning the output fiber 8 with the lens 4; and aligning the lens 2 and filter 3 with the lens 4. As a result of these steps, the fiber tube 1 is laterally offset from the lens 2, the fiber tube 5 is laterally offset from the lens 4, and the lens 4 is laterally offset from the lens 2.

A great deal of time and effort is spent aligning the aforementioned elements in an effort to optically couple them with the least amount of loss. U.S. Pat. No. 6,168,319, issued to Kurt R. Francis on Jan. 2, 2001, discloses a system and method for aligning optical fiber collimators by simply moving the lens or ferrule longitudinally in the mounting sleeve. However, this system may not be useful in aligning all of the elements of the centerpiece. One major reason for this is the walk-off caused by the optical component, i.e. it may not be possible to adjust the distance between the lenses whereby the walk-off is eliminated.

Two examples of systems for compensating for the walk-off caused by the optical component are disclosed in U.S. Pat. Nos. 6,014,484 issued to Gary S. Duck et al on Jan. 11, 2000, and 6,142,678 issued to Yihao Cheng on Nov. 7, 2000. Both of these systems are very effective, but result in centerpieces that are not coaxial. There is now a growing desire to manufacture optical centerpieces that are coaxial, which will enable the entire assembly to be mounted in a single mounting sleeve instead of two or more separate sleeves that require joining. A single sleeve will eliminate the possibility of epoxy finding its way between the lenses and affecting the insertion loss, and eliminate a potential pathway for moisture entering the assembly when in an environment of higher humidity.

An object of the present invention is to overcome the shortcomings of the prior art by providing a method of aligning optical elements to minimize insertion losses. Another object of the present invention is to provide an optically coupled device, including a centerpiece with coaxial elements, an input ferrule, and an output ferrule, that is assembled with the elements oriented to overcome walk-off caused by an optical component in the centerpiece.

### SUMMARY OF THE INVENTION

Accordingly the present invention relates to a method of optically coupling elements of an optical device, the elements comprising: a first ferrule with at least one fiber extending therethrough; a first lens; an optical component creating a walk-off; a second lens; and an second ferrule with at least one fiber extending therethrough. The first ferrule and the first lens have opposing end faces. The second ferrule and the second lens have opposing end faces. One of the elements selected from the group consisting of: the first ferrule, the second ferrule, the first lens, and the second lens, has an angled end face. The method comprises the steps of:

a) co-axially mounting the first lens and the second lens with the optical component positioned there between forming a centerpiece;

b) positioning the first and second ferrules on either end of the centerpiece;

c) rotating the element with the angled end face about its optical axis to overcome at least some of the walk-off caused by the optical component until sufficient optical coupling is achieved; and

d) fixing the elements together.

Another aspect of the present invention relates to an optical device comprising:

a first ferrule element, having a first optical fiber extending there through to an end face, for inputting or outputting a beam of light along an optical path;

a first lens element for collimating or focusing the beam of light, the first lens element having an end face opposite the end face of the first ferrule element;

an optical component receiving the collimated beam of light, and causing the optical beam to walk-off from the optical path;

a second lens element for focusing or collimating the beam of light, the second lens element having an end face; and

a second ferrule element for outputting or inputting the beam of light, the second ferrule element having a second optical fiber extending there through to an end face, which is opposite the end face of the second lens element;

wherein the first lens element and the second lens element are coaxial;

wherein one of the elements selected from the group consisting of: the first ferrule element, the second ferrule element, the first lens element, and the second lens element has an angled end face for steering the beam of light; and

wherein the element with the angled end face is positioned with an azimuth angle relative to a longitudinal axis thereof to overcome at least part of the walk-off caused by the optical component.

Another aspect of the present invention relates to a method of optically coupling elements of an optical device, the elements comprising: a first ferrule with at least one fiber extending there through for inputting or outputting a beam of light along a path; a first lens; an optical component that causes the beam of light to walk-off from the path; a second lens; and an second ferrule with at least one fiber extending there through. The first ferrule and the first lens have opposing end faces. The second ferrule and the second lens have opposing end faces. One of the elements selected from the group consisting of: the first ferrule, the second ferrule, the first lens, and the second lens, has an angled end face. The method comprises the steps of:

a) co-axially mounting the first lens and the second lens with the optical component positioned there between forming a centerpiece;

b) positioning the first and second ferrules on either end of the centerpiece, whereby the first and second ferrules are optically coupled to each other via the centerpiece; and

c) fixing the elements together, whereby the element with the angled end face has an azimuth angle relative the longitudinal axis thereof based on the walk-off caused by the optical component.

### BRIEF DESCRIPTION OF THE DRAWINGS

The invention will be described in greater detail with reference to the accompanying drawings, which represent a preferred embodiment of the invention, and wherein:

FIG. 1 is a schematic side view of a convention optical centerpiece device with fiber pigtails connected thereto;

FIG. 2 is a schematic side view of the elements of the axially aligned optical centerpiece optically coupled to input and output fibers using an embodiment of the method of the present invention;

FIG. 3 is a schematic perspective view of a ferrule and a lens, illustrating the effect of rotating the ferrule;

FIG. 4 is a schematic perspective view of the elements of FIG. 3, illustrating the effect of rotating the ferrule and the lens in combination; and

FIG. 5 is a schematic side view of the elements of the axially aligned optical centerpiece optically coupled to input and output fibers using another embodiment of the method of the present invention.

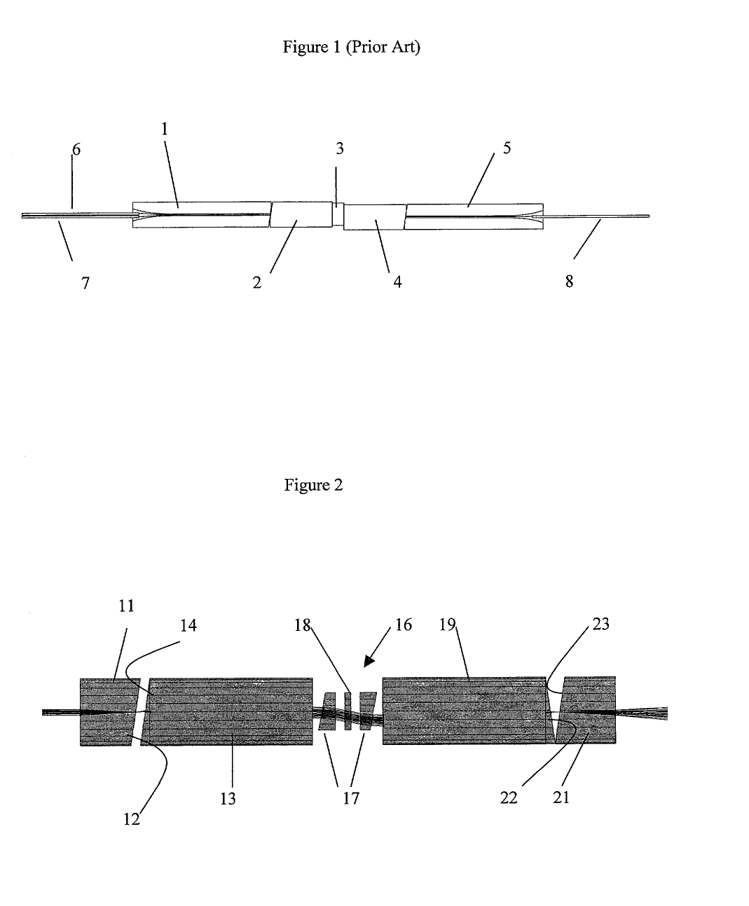

### DETAILED DESCRIPTION

With reference to FIG. 2, the elements of the present invention are illustrated in the desired alignment with the optical, i.e. longitudinal, axes of the lenses aligned. This coaxial alignment is desirable for the reasons stated above. An input ferrule 11, which encases at least one fiber (not shown), has an angle polished face 12. Collimating (GRIN) lens 13 also has an angle polished face 14, which is opposite to face 12. Normally, the faces 12 and 14 are parallel, i.e. both have an azimuth angle of 0°, so that a beam of light will enter the lens 13 along the optical axis thereof. The angle of the end faces 12 and 14, e.g. 8° to 10° is provided to minimize back reflection of light from the lens 13 back into the fiber. The optical component illustrated in FIG. 2 is an isolator, generally indicated at 16, comprising birefringent polarizing wedges 17 and a non-reciprocal rotator 18.

A focusing (GRIN) lens 19 receives the light and focuses it on a fiber (not shown) encased in an output ferrule 21. The opposing surfaces 22 and 23 of the focusing lens 19 and the output ferrule 21, respectively, are also angle polished for the reasons stated above. As illustrated in FIG. 2, the optical component 16 causes the light to walk-off from the optical axis of the focusing lens 19. This walk-off causes the light to exit the lens 19 at an angle, which, although slight, causes a significant amount of optical loss. According to the present invention, to compensate for this misalignment one of the elements with an angled end surface, i.e. the input ferrule 11, the collimating lens 13, the focusing lens 19 or the ferrule 21, is rotated about the longitudinal (optical) axis thereof, which enables the light to be refracted in a different direction. The rotation of the element with the angled end surface steers the beam to an appropriate position, which takes into account the walk-off caused by the optical component 16. In the example illustrated in FIG. 2, the ferrule 21 is rotated by 180° about the longitudinal axis thereof, i.e. the ferrule has an azimuth angle of 180°. Unfortunately, in most cases the rotation of a single element alone does not provide the required compensation. Therefore, in order to increase the chance of obtaining optical coupling two of the elements with angle end faces are rotated, thereby providing two degrees of freedom by which to steer the beam. Normally, rotation of both the lens 19 and the ferrule 21 can provide the necessary compensation. Although, it is also possible to rotate both of the ferrules 11 and 21, both of the lenses 13 and 19 or both the lens 13 and the ferrule 11. Rotation of three or more of the elements is also conceivable but usually not necessary.

In the illustrated example, all of the opposed end faces 12, 14, 22 and 23 are angled. This is a preferred embodiment, since it is only necessary for the element or elements that are being rotated to have angled end faces, which enable the beam to be steered accordingly.

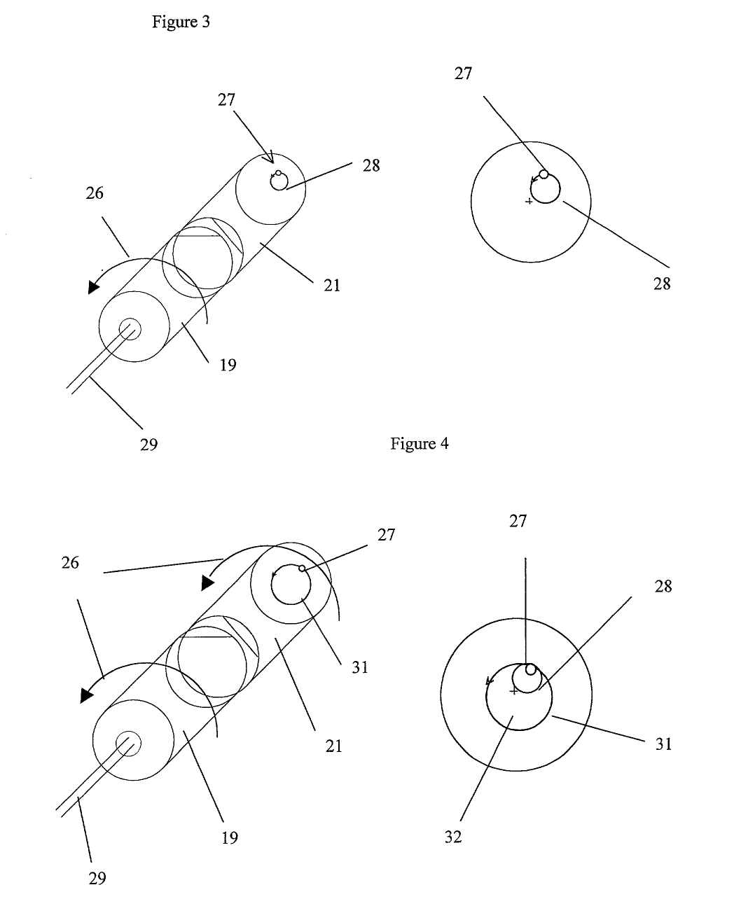

With reference to FIG. 3, rotation of the ferrule 19 in the direction indicated by arrow 26 results in a principal ray 27 tracing a path 28 in the plane conjugate to the input optical fiber 29. The path 28 defines a path traced out by the principal ray as the ferrule 19 is rotated about its longitudinal axis. FIG. 4 illustrates the advantage gained by the combined rotation of both the lens 19 and the ferrule 21. In this case, by rotating both the lens 19 and the ferrule 21 in the direction indicated by arrows 26, the principal ray 27 traces a path 31. By superimposing the path 31 over the path 28 (see FIG. 4) we define a region 32, within which the beam can be steered to optimize the optical coupling with the output fiber (not shown). Stating this another way, the outer limit of the region 32 is defined by the addition of the deviation of the beam from the optical axis caused by the fiber and the deviation of the beam from the optical axis caused by the lens, while the inner limit is defined by the subtraction of the deviation of the beam from the optical axis caused by the fiber from the deviation of the beam from the optical axis caused by lens. When these deviations are equal the minimum radius is zero.

Mathematically the region can be defined as rₘᵢₙ≦r≦rₘₐₓ

Where rₘᵢₙ≈0 or f*(θ₂(1-1/n₂)−θ₁-1(n₁-1)/n₂) whichever is greater;

and

rₘₐₓ≈f*(θ₁(1-1/n₂)+θ₂(n₁-1)/n₂)

θ₁-endface angle of the fiber

θ₂-endface angle of the lens

n₁ -effective index of refraction of the fiber

n₂ -axial index of refraction of the lens

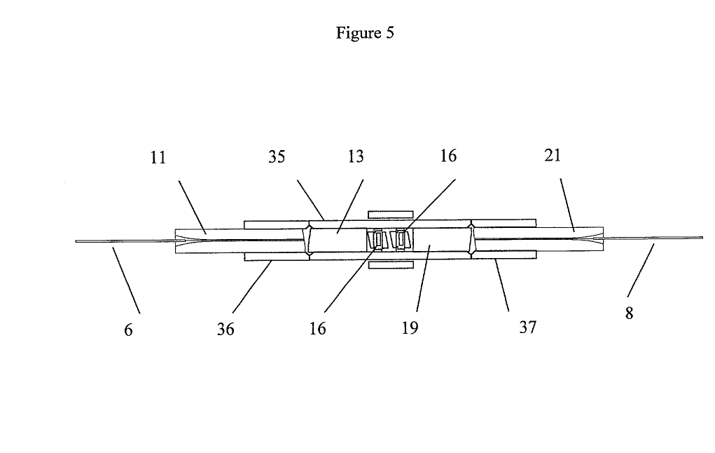

The maximum walk off compensation, as illustrated in FIG. 5, occurs when both of the ferrules 11 and 21 have been rotated by 180° from the position in which the faces 12 and 23 are parallel to the faces 14 and 22, respectively. In other words the ferrules 11 and 21 are oriented with an azimuth angle of 180° with respect to each of their longitudinal axes. Assuming the lenses 13 and 19 and the ferrules 11 and 21 have end faces angled at 10° from the vertical, the sum of the contributions from both are approximately: 2 *f*tan((n₁-1)θ₁₊(n₂-1)θ₂)=720 microns.

FIG. 5 illustrates an example of a completed optical device in which the optical component is comprised of two isolators 16, and the elements of the centerpiece are mounted coaxially in a sleeve 35. Input ferrule 11, with input fiber 6, are fixed in a mounting collar 36, and output ferrule 21 with output fiber 8 are fixed in a mounting collar 37. In the illustrated example, the input ferrule 11 has been oriented with an azimuth angle of 180°, and the output ferrule 21 has been oriented with an azimuth angle of 180° relative to collimating lens 13 and focusing lens 19, respectively. After the lateral (x, y or z) adjustments of the ferrules 11 and 21 have been completed, the collars 36 and 37 are fixed to the sleeve 35 using any convenient method and/or adhesive.

The aforementioned method may be practiced as a fully active alignment process or a partially active process; however, it is also possible to pre-align the elements, if the walk-off the optical component is known. For example, the walk-off resulting from a thin film filter is dependent on the angular position of the end face of the ferrule with common and reflected ports. To optimize the design requires the relationship between the line connecting the centers of the two fibers and the orientation of the normal of the end face to be known. Based on this relationship, the parts can be fabricated to the correct dimensions. This pre-alignment makes it possible to adjust either or both of the lenses 13 and 19, and either or both of the ferrules 11 and 21 according to manufacturing and design criteria. Accordingly, the device can be assembled with the angle-faced elements already oriented to compensate for the walk off from the optical component, i.e. the elements are assembled with their azimuth angles predetermined.

A partially active alignment system involves presetting the angular relationships of the angled faces, by arranging the elements at preset azimuth angles, and then adjusting the position of the ferrules laterally, i.e. x, y, z directions. The fully active alignment process involves rotating one or more of the elements with angled end faces, and laterally adjusting the ferrules to obtain the desired (e.g. maximum) optical coupling.

We claim:

1. A method of optically coupling elements of an optical device, the elements comprising: a first ferrule with at least one fiber extending therethrough; a first lens; an optical component, which creates a walk-off; a second lens; and an second ferrule with at least one fiber extending therethrough; wherein the first ferrule and the first lens have opposing end faces; wherein the second ferrule and the second lens have opposing end faces; and wherein one of the elements selected from the group consisting of: the first ferrule, the second ferrule, the first lens, and the second lens, has an angled end face, the method comprising the steps of:
a) co-axially mounting the first lens and the second lens with the optical component positioned there between forming a centerpiece;
b) positioning the first and second ferrules on either end of the centerpiece;
c) rotating the element with the angled end face about its optical axis to overcome at least some of the walk-off caused by the optical component until sufficient optical coupling is achieved; and
d) fixing the elements together.

2. The method according to claim 1, wherein the first or the second lens has an angled end face, wherein the first or the second ferrule has an angled end face, and wherein step c) comprises rotating the lens with the angle end face and rotating the ferrule with the angled end face until sufficient coupling is achieved.

3. The method according to claim 1, wherein the first and the second ferrule have angled end faces, and wherein step c) comprises rotating the first and the second ferrule until sufficient coupling is achieved.

4. The method according to claim 1, wherein the first ferrule, the second ferrule, the first lens, and the second lens all have angle end faces; and wherein step c) comprises rotating at least two of the elements selected from the group consisting of: the first ferrule, the second ferrule, the first lens, and the second lens until sufficient coupling is achieved.

5. The method according to claim 1, wherein step d) comprises fixing the optical component, the first lens, and the second lens in a sleeve, and fixing the first and second ferrules on each end of the sleeve.

6. The method according to claim 5, wherein the first ferrule is mounted in a first collar and the second ferrule is mounted in a second collar; wherein step c) further comprises laterally adjusting the position of at least one of the first or the second ferrule; and wherein step d) further comprises fixing the first collar to one end of the sleeve and fixing the second collar to the other end of the sleeve.

7. An optical device comprising:
a first ferrule element, having a first optical fiber extending there through to an end face, for inputting or outputting a beam of light along an optical path;
a first lens element for collimating or focusing the beam of light, the first lens element having an end face opposite the end face of the first ferrule element;
an optical component receiving the collimated beam of light, and causing the optical beam to walk-off from the optical path;
a second lens element for focusing or collimating the beam of light, the second lens element having an end face; and
a second ferrule element for outputting or inputting the beam of light, the second ferrule element having a second optical fiber extending there through to an end face, which is opposite the end face of the second lens element;
wherein the first lens element and the second lens element are coaxial;
wherein one of the elements selected from the group consisting of: the first ferrule element, the second ferrule element, the first lens element, and the second lens element has an angled end face for steering the beam of light; and
wherein the element with the angled end face is positioned with an azimuth angle relative to a longitudinal axis thereof to overcome at least part of the walk-off caused by the optical component.

8. The device according to claim 7, wherein two elements selected from the group consisting of: the first ferrule element, the second ferrule element, the first lens element, and the second lens element have angled end faces for steering the beam of light; and wherein the two elements are positioned at predetermined azimuth angles to overcome at least part of the walk-off caused by the optical component.

9. The device according to claim 8, wherein the opposite end faces of the second lens element and the second ferrule element are angled for steering the beam of light; and wherein the second lens element and the second ferrule element are positioned at predetermined azimuth angles to substantially overcome the walk-off caused by the optical component.

10. The device according to claim 8, wherein the end face of the first ferrule element and the end face of the second ferrule element are angled for steering the beam of light; and wherein the first and second ferrule elements are positioned at predetermined azimuth angles to substantially overcome the walk-off caused by the optical component.

11. The device according to claim 7, wherein the first lens element, the optical component, and the second lens element are mounted in a sleeve forming a centerpiece.

12. The device according to claim 11, wherein the first ferrule element is mounted in a first collar, and the second ferrule element is mounted in a second collar; and wherein the first collar is fixed to one end of the sleeve, and the second collar is fixed to the other end of the sleeve.

13. The device according to claim 7, wherein the first and the second lens elements are graded index lenses.

14. The device according to claim 7, further comprising a third optical fiber extending through the first ferrule element.

15. The device according to claim 7, wherein the optical component is at least one optical component selected from the group consisting of an isolator, a thin-film filter, a waveplate, and a beam splitter.

16. A method of optically coupling elements of an optical device, the elements comprising: a first ferrule with at least one fiber extending there through for inputting or outputting a beam of light along a path; a first lens for collimating or focusing the beam of light; an optical component that causes the beam of light to walk-off from the path; a second lens for focusing or collimating the beam of light; and an second ferrule with at least one fiber extending there through; wherein the first ferrule and the first lens have opposing end faces; wherein the second ferrule and the second lens have opposing end faces; and wherein one of the elements selected from the group consisting of: the first ferrule, the second ferrule, the first lens, and the second lens, has an angled end face, the method comprising the steps of:
a) co-axially mounting the first lens and the second lens with the optical component positioned there between forming a centerpiece;
b) positioning the first and second ferrules on either end of the centerpiece, whereby the first and second ferrules are optically coupled to each other via the centerpiece; and
c) fixing the elements together, whereby the element with the angled end face has an azimuth angle relative to a longitudinal axis thereof based on the walk-off caused by the optical component to at least partially compensate therefore.

17. The method according to claim 16, wherein the first or the second lens has an angled end face; wherein the first or the second ferrule has an angled end face; and wherein the lens with the angle end face and the ferrule with the angled end face are oriented such that the angled end faces steer the beam of light to at least partially compensate for the walk-off caused by the optical component.

18. The method according to claim 16, wherein the first and the second ferrule have angled end faces, and wherein the first and second ferrule are oriented such that the angled end faces steer the beam of light to at least partially compensate for the walk-off caused by the optical component.

19. The method according to claim 16, wherein the first ferrule, the second ferrule, the first lens, and the second lens all have angle end faces; and wherein at least two of the elements selected from the group consisting of: the first ferrule, the second ferrule, the first lens, and the second lens are oriented such that the angled end faces steer the beam of light to at least partially compensate for the walk-off caused by the optical component.

20. The method according to claim 16, wherein step c) comprises fixing the optical component, the first lens, and the second lens in a sleeve, and fixing the first and second ferrules on each end of the sleeve.

21. The method according to claim 20, wherein the first ferrule is mounted in a first collar and the second ferrule is mounted in a second collar; wherein step b) further comprises laterally adjusting the position of at least one of the first or the second ferrule; and wherein step c) further comprises fixing the first collar to one end of the sleeve and fixing the second collar to the other end of the sleeve.
